(19) United States
(12) Patent Application Publication
(10) Pub. No.: US 2017/0284249 A1
(43) Pub. Date: Oct. 5, 2017

(54) EXHAUST SYSTEM HAVING HYBRID COOLING ARRANGEMENT

(71) Applicant: Caterpillar Inc., Peoria, IL (US)

(72) Inventor: Sean Patrick OILAR, Wolcott, IN (US)

(73) Assignee: Caterpillar Inc., Peoria, IL (US)

(21) Appl. No.: 15/089,972

(22) Filed: Apr. 4, 2016

(51) Int. Cl. F01N 3/04; F01P 3/20; F01N 13/18; F02B 37/02; F01N 13/14

(52) U.S. Cl. CPC F01N 3/046; F02B 37/025; F01N 13/14; F01N 13/1805; F01P 3/20; F01N 2590/02; F01P 2060/16

(57) ABSTRACT

An exhaust system is disclosed for a use with an engine. The exhaust system may have a plurality of manifold sections, each being connected to an adjacent one of the plurality of manifold sections and thereby forming an exhaust manifold. The exhaust system may also have a plurality of elbow-shaped coolant adapters, each being configured to connect a corresponding one of the plurality of manifold sections to a corresponding cylinder head of the engine and having a coolant jacket formed therein. The exhaust system may further have a heat shield formed around the exhaust manifold.

### TECHNICAL FIELD

The present disclosure is directed to an exhaust system and, more particularly, to an exhaust system having a hybrid cooling arrangement.

### BACKGROUND

Internal combustion engines such as diesel engines, gasoline engines, and gaseous fuel-powered engines combust a mixture of fuel and air to generate a mechanical power output that can be used in many different ways for a variety of purposes. Unfortunately, conventional engines are inefficient, and much of the energy of the fuel is converted to heat. For example, heat can be generated during compression of combustion air directed into the engine or during pumping of fluids (e.g., fuel, air, lubricant, etc.) through the engine. Additional heat is generated directly from combustion of the fuel and air, and is transferred to the engine block and to fluids (oil, coolant, exhaust, etc.) circulating through the block. Most of this heat energy is eventually discharged or otherwise dissipated to the environment.

In some applications, the waste exhaust heat generated as a byproduct of engine operation can be used to drive a turbocharger. The turbocharger increases engine power by forcing more air into the combustion chambers than would otherwise be possible. This increased amount of air allows for enhanced fueling that further increases the power output of the engine.

When a combustion engine is used in a marine application, the engine must adhere to special regulations regarding skin temperature. In particular, a maximum temperature of any outer surface of the engine must remain below an established threshold throughout operation of the engine. The established threshold may be lower than a combustion initiation temperature of elements (e.g., of fuel, oil, etc.) from a surrounding environment that could possibly come into contact with the engine. In order to meet these regulations, hotter parts of the engine are commonly cooled and/or shielded from the environment. Care should be taken during cooling of the engine, however, to ensure that exhaust discharging from the engine is not too low to efficiently drive any associated turbochargers.

U.S. Pat. No. 2,760,593 (the '593 patent) that issued to Hoitt on Aug. 28, 1956 discloses an exemplary exhaust device for a marine internal combustion engine. The exhaust device includes an exhaust manifold, a muffler, an exhaust pipe extending from the exhaust manifold into the muffler, and a water jacket surrounding the exhaust pipe. Water is directed into the water jacket and passes through a spacer member into the muffler, where the water mixes with exhaust from the exhaust pipe and exits the muffler.

Although the water jacket of the '593 patent may help to reduce a temperature of the exhaust pipe, the water jacket may be less than optimal. In particular, the exhaust manifold being uncooled and unshielded, may still have temperatures higher than a threshold regulation. Further, the waterj acket may lower a temperature of the exhaust too far, making use of a turbocharger inefficient or even impossible. Finally, mixing the water with the exhaust could make the water caustic and thereby inhibit recirculation and reuse of the water.

The disclosed exhaust system is directed to overcoming one or more of the problems set forth above and/or other problems of the prior art.

### SUMMARY

In one aspect, the disclosure is directed toward a coolant adapter for an engine. The coolant adapter may include an elbow-shaped conduit having an exhaust inlet connectable to a cylinder head of the engine and an exhaust outlet connectable to an exhaust manifold of the engine. The coolant adapter may also include a jacket formed around at least a portion of the elbow-shaped conduit.

In another aspect, the disclosure is related to an exhaust system for an engine. The exhaust system may include a plurality of manifold sections, each being connected to an adjacent one of the plurality of manifold sections and thereby forming an exhaust manifold. The exhaust system may also include a plurality of elbow-shaped coolant adapters, each being configured to connect a corresponding one of the plurality of manifold sections to a corresponding cylinder head of the engine and having a coolant jacket formed therein. The exhaust system may further include a heat shield formed around the exhaust manifold.

In yet another aspect, the disclosure is directed toward a power system. The power system may include an engine having a plurality of cylinder heads, and a plurality of manifold sections configured to connect with each other and thereby form an exhaust manifold. Each of the plurality of manifold sections may have an integral exhaust runner extending from an annular wall. The power system may further include a plurality of a coolant adapters, each configured to connect the integral exhaust runner to a corresponding one of the plurality of cylinder heads, and having a jacket formed therein. The power system may additionally include a plurality of couplings, each configured to connect a coolant outlet of the corresponding one of the plurality of cylinder heads with the jacket via an outboard side of a corresponding one of the plurality of coolant adapters. The power system may also include a coolant manifold configured to receive coolant from the plurality of coolant adapters via an inboard side of each of the plurality of coolant adapters, a heat shield formed around the exhaust manifold, and a turbocharger driven by exhaust in the exhaust manifold to pressurize air directed into the engine.

### BRIEF DESCRIPTION OF THE DRAWING

FIGS. 1 and 2 are perspective and end-view illustrations, respectively, of an exemplary disclosed power system;

FIG. 3 is a perspective illustration of an exemplary disclosed exhaust system that may be used in conjunction with the power system of FIGS. 1 and 2; and

FIGS. 4 and 5 are perspective illustrations of exemplary disclosed portions of the exhaust system of FIG. 3.

### DETAILED DESCRIPTION

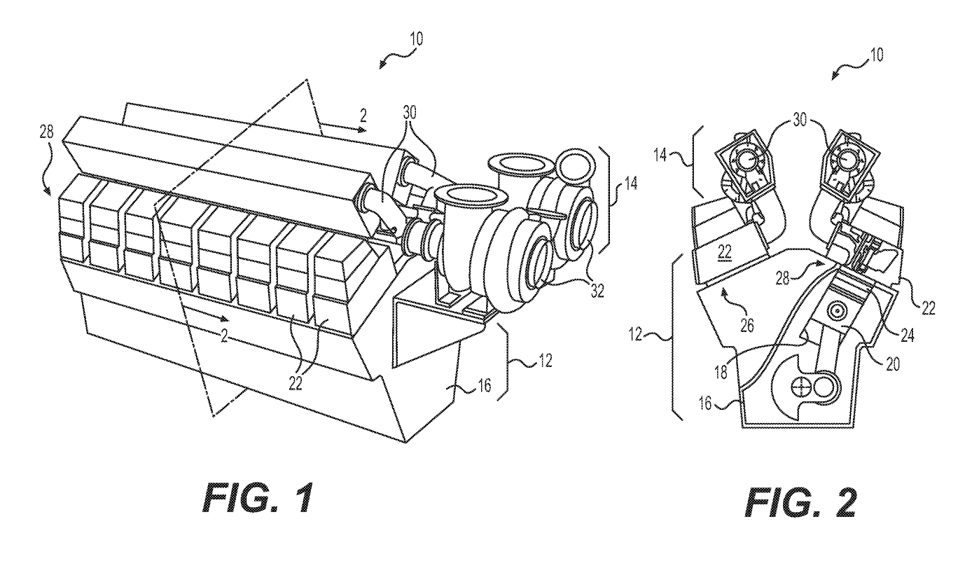

FIGS. 1 and 2 illustrate an exemplary power system 10 having an engine 12 equipped with an exhaust system 14. For the purposes of this disclosure, engine 12 is depicted and described as a four-stroke diesel engine. One skilled in the art will recognize, however, that engine 12 may be any other type of combustion engine such as, for example, a gasoline or a gaseous fuel-powered engine. Engine 12 may include an engine block 16 that at least partially defines a plurality of cylinders 18. A piston 20 may be slidably disposed within each cylinder 18, and a cylinder head 22 may be associated with each cylinder 18. Cylinder 18, piston 20, and cylinder head 22 may together form a combustion chamber 24. In the illustrated embodiment, engine 12 includes sixteen such combustion chambers 24 arranged into a first bank 26 and a second bank 28 (i.e., arranged into a V-configuration). However, it is contemplated that engine 12 may include a greater or lesser number of combustion chambers 24 arranged in an inline-configuration or in any other conventional configuration, if desired.

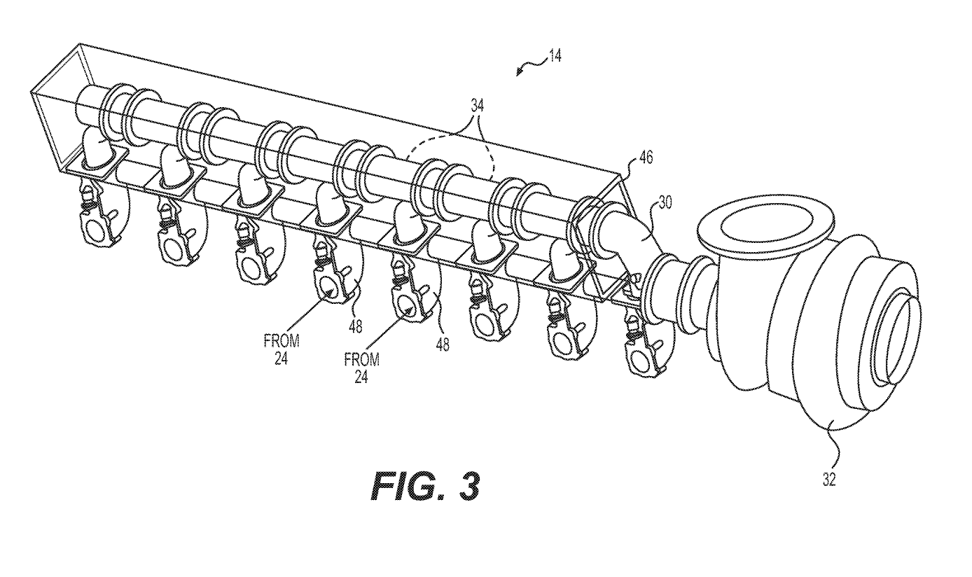

As shown in FIG. 3, exhaust system 14 may include components that cooperate to transport exhaust away from engine 12. Specifically, exhaust system 14 may include one or more exhaust manifolds 30 that are in fluid communication with combustion chambers 24 of banks 26 and 28, and any number of turbochargers 32 powered by the exhaust in manifold 30. Each exhaust manifold 30 may extend along a general length direction of engine 12 (e.g., at a lateral location inboard from cylinder heads 22) and terminate at turbocharger 32. Energy removed from the exhaust exiting combustion chambers 24 may be utilized to drive turbocharger 32 and compress inlet air consumed by engine 12, as is known in the art. The exhaust from engine 12, after exiting turbocharger 32, may pass through one or more aftertreatment devices (not shown) before being released to the atmosphere. It is contemplated that engine 12 could be naturally aspirated (i.e., that turbochargers 32 may be omitted), if desired.

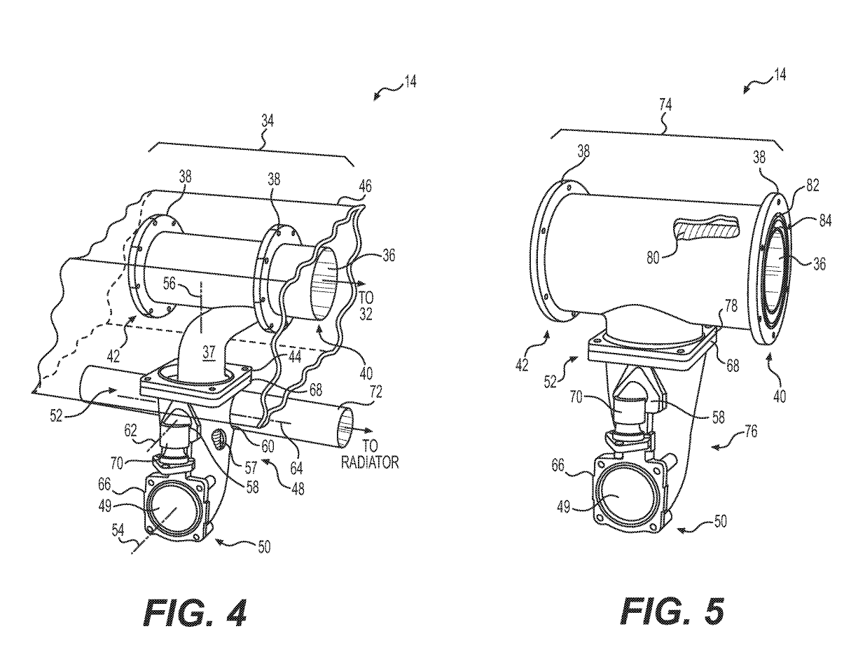

Each exhaust manifold 30 may be an assembly of multiple manifold sections 34, which are joined end-to-end in an axial direction. As shown in FIG. 4, each manifold section 34 may include a central conduit 36, an integral supply runner 37 intersecting an annular side wall of central conduit 36, and mounting flanges 38 located at opposing ends of conduit 36 that allow for axial connection to adjacent manifold sections 34. In the disclosed embodiment, a downstream end 40 of each manifold section 34 is necked-down and protrudes a distance from the associated mounting flange 38 for insertion into an upstream end 42 of the adjacent manifold section 34. It is contemplated that a gasket or other sealing mechanism (not shown) could be placed between mating mounting flanges 38, if desired. Runner 37 may protrude from central conduit 36 downward toward an associated cylinder head 22 (referring to FIGS. 1 and 2), and have a mounting flange 44 formed at a distal end thereof.

Depending on an intended application of engine 12, a skin temperature of exhaust system 14 may need to be lowered in order for engine 12 to be compliant with associated regulations. In the embodiment of FIG. 4, the skin temperature of exhaust system 14 is being lowered via a hybrid arrangement (i.e., an arrangement of two different mechanisms). In particular, the skin temperature of manifold section 34 is being lowered via a heat shield 46 and via a coolant adapter 48 that is used to connect each manifold section 34 to a corresponding cylinder head 22.

Heat shield 46 may embody any type of heat shield known in the art. In disclosed example, heat shield 46 is a rigid-type of shield. However, it is contemplated that heat shield 46 could be a flexible or a hybrid type of shield if desired. Heat shield 46 may consist of any number of layers (e.g., an outer layer, an inner layer, and one or more intermediate layers) made from any type of material. If multiple layers are included, an inner layer may be fabricated from a reflective material (e.g., foil), an outer layer may be fabricated from a more durable and/or flexible material (e.g., silicon), while any intermediate layer(s) may be fabricated from an insulative material (e.g., a porous or corrugated material).

Heat shield 46 may be installed in sections (e.g., one section per one or more manifold sections 34) and/or in parts (e.g., an inside part and an outside part, a top part and a bottom part, individual walls, etc.), and supported by any surrounding structure (e.g., by manifold sections 34, by mounting flanges 38 and/or 44, by dedicated support structure—not shown, etc.). In some embodiments, heat shield 46 may completely surround each manifold section 34 (e.g., on all four sides—top, bottom, inboard side, outboard side). However, in other embodiments, heat shield 46 may not be required at a location below central conduit 36 (i.e., the bottom may be omitted). Heat shield 46 may terminate at about the distal end of runners 37 (i.e., only be used to lower a temperature of manifold sections 34), as it may be too difficult and/or geometrically complex to install heat shield 46 at lower locations (i.e., locations closer to engine block 16 and between cylinder banks 26 and 28—referring to FIGS. 1 and 2).

Coolant adapter 48 may function to connect runner 37 of manifold section 34 to a corresponding cylinder head 22 (referring to FIGS. 1 and 2), and also to lower a skin temperature of exhaust system 14 at difficult-to-reach locations not already being addressed by heat shield 46. Coolant adapter 48 may include an elbow-shaped conduit 49 having an exhaust inlet 50 configured to mate against an inward-facing surface of cylinder head 22, and an exhaust outlet 52 configured to mate against a downward-facing surface of mounting flange 44. An axis 54 of coolant adapter 48 at inlet 50 may form an interior angle with an axis 56 at outlet 52 that is about 60-120° (e.g., about 90°). A jacket 57 may be formed around at least a portion of conduit 49 (e.g., around at least the portion aligned with axis 56), and have a coolant inlet 58 formed within an outboard side wall and a coolant outlet 60 formed opposite inlet 58 within an inboard side wall. An axis 62 of coolant inlet 58 may be generally parallel with axis 54 of exhaust inlet 50 and oriented toward cylinder head 22, while an axis 64 of coolant outlet 60 may be generally orthogonal to axes 54, 56, and 62. A mounting flange 66 may be formed at exhaust inlet 50 for engagement with cylinder head 22, and a similar mounting flange 68 may be formed at exhaust outlet 52 for engagement with mounting flange 44 of runner 37.

A coupling 70 may be used to couple coolant inlet 58 of coolant adapter 48 with a supply of coolant. In the disclosed example, the supply of coolant is cylinder head 22. In particular, coupling 70 may be configured to connect an outlet port located at an upper surface of cylinder head 22 with coolant inlet 58. In this example, coupling 70 is an elbow having mounting flanges located at opposing ends. In other examples, however, coupling 70 could have a different shape and/or embody a tube, a flexible hose, or a differently type of coupling, if desired. The coolant received from cylinder head 22 may have already passed through engine 12 and absorbed heat therefrom. A temperature of this coolant, however, may still be low enough to provide an acceptable skin temperature at the associated location. Thereafter, the coolant may exit adapter 48 to join with coolant exiting other adjacent adapters 48 and flow through a coolant manifold 72 to a heat exchanger (e.g., a radiator—not shown) where heat in the coolant may be dissipated to the environment before the coolant is returned to engine 12.

An alternative embodiment of exhaust system 14 is illustrated in FIG. 5 that is similar the embodiment shown in FIG. 4. In particular, in the embodiment of FIG. 5, exhaust system 14 includes exhaust manifold 30 being made up of manifold sections 74 that are different than manifold sections 34. In this embodiment, each manifold section 74 includes an exhaust conduit 36, but does not include an associated supply runner. In addition, downstream end 40 does not protrude from mounting flange 38 and is not necked-down. Instead, a different coolant adapter 76 is configured to function as both an adapter and a supply runner, and manifold sections 74 may only abut each other at their axial ends. A mounting flange 78 may be formed at the annular side of manifold section 74, and coolant adapter 76 may connect directly to manifold section 74 mounting flange 78. In addition, each manifold section 74 may include a jacket 80 formed around exhaust conduit 36. Jacket 80 may receive coolant from adapter 76 (e.g., an axial flow directed through mounting flanges 68, 78), and pass the coolant to a next downstream manifold section 74 via a concentric outlet 82 located around conduit 36. One or more seals 84 (e.g., o-rings) may be located within mounting flanges 38, 68, and/or 78 to inhibit leakage at these locations. Coolant manifold 72 may be omitted in this embodiment, as all coolant may collect within and flow together to the radiator via jackets 80 of each of manifold sections 74. It is contemplated that jacket 80 may be used in addition to heat shield 46 (referring to FIG. 4) or in place of heat shield 46, as desired.

### INDUSTRIAL APPLICABILITY

The disclosed exhaust system may be implemented into any power system application where maximum engine skin temperatures are regulated. The disclosed exhaust system may reduce a skin temperature of engine 12 by way of a unique combination of coolant jackets and heat shields. In addition, the disclosed combinations may allow for assembly simplicity and lower costs, without reducing an efficiency of engine 12. In some embodiments, for example in engines employing exhaust recirculation for lower emissions, the disclosed system may also help to reduce a temperature of the exhaust prior to recirculation of the exhaust back to an inlet of the engine.

It will be apparent to those skilled in the art that various modifications and variations can be made to the disclosed exhaust system. Other embodiments will be apparent to those skilled in the art from consideration of the specification and practice of the disclosed exhaust system. It is intended that the specification and examples be considered as exemplary only, with a true scope being indicated by the following claims and their equivalents.

What is claimed is:

1. A coolant adapter for an engine, comprising:
an elbow-shaped conduit having an exhaust inlet connectable to a cylinder head of the engine and an exhaust outlet connectable to an exhaust manifold of the engine; and
a jacket formed around at least a portion of the elbow-shaped conduit.

2. The coolant adapter of claim 1, wherein axes of the exhaust inlet and outlet are oriented at an interior angle of about 60-120° relative to each other

3. The coolant adapter of claim 2, wherein the interior angle is about 90°.

4. The coolant adapter of claim 1, wherein the jacket includes a coolant inlet having an axis generally parallel with an axis of the exhaust inlet.

5. The coolant adapter of claim 4, wherein the coolant inlet is formed within an outboard side wall of the jacket and connectable with a coolant supply in the cylinder head.

6. The coolant adapter of claim 4, wherein the jacket further includes a coolant outlet having an axis generally orthogonal to axes of both the exhaust inlet and outlet.

7. The coolant adapter of claim 4, further including a mounting flange located at a downstream end of the elbow-shaped conduit, the mounting flange having:
the exhaust outlet centrally located therein; and
a concentric coolant outlet in communication with the jacket.

8. An exhaust system for an engine, comprising:
a plurality of manifold sections, each being connected to an adjacent one of the plurality of manifold sections and thereby forming an exhaust manifold;
a plurality of elbow-shaped coolant adapters, each being configured to connect a corresponding one of the plurality of manifold sections to a corresponding cylinder head of the engine and having a coolant jacket formed therein; and
a heat shield formed around the exhaust manifold.

9. The exhaust system of claim 8, wherein:
the coolant jacket is a first coolant jacket; and
each of the plurality of manifold sections includes a second coolant jacket formed therein that is in fluid communication with the first coolant jacket.

10. The exhaust system of claim 8, further including a coolant manifold configured to receive coolant from the coolant jacket via an inboard side of each of the plurality of elbow-shaped coolant adapters.

11. The exhaust system of claim 8, further including a coupling configured to direct coolant from the corresponding cylinder head into the coolant jacket via an outboard side of each of the plurality of elbow-shaped coolant adapters.

12. The exhaust system of claim 8, wherein each of the plurality of elbow-shaped coolant adapters has an interior angle of about 90°.

13. The exhaust system of claim 8, wherein the coolant jacket includes a coolant inlet having an axis generally parallel with an exhaust inlet of each of the plurality of elbow-shaped coolant adapters.

14. The exhaust system of claim 8, further including an exhaust runner connecting each of the plurality of manifold sections to each of the plurality of elbow-shaped coolant adapters.

15. The exhaust system of claim 8, wherein each of the plurality of elbow-shaped coolant adapters further includes a first mounting flange located at an end thereof and configured to engage a corresponding second mounting flange on each of the plurality of manifold sections, the first mounting flange having:
an exhaust outlet centrally located therein; and
a concentric coolant outlet formed around the exhaust outlet.

16. The exhaust system of claim 15, wherein the heat shield is supported by at least one of the first and second mounting flanges.

17. The exhaust system of claim 16, wherein the heat shield encompasses the exhaust manifold on at least three sides.

18. The exhaust system of claim 16, wherein the heat shield encompasses the exhaust manifold on four sides.

19. A power system, comprising:
an engine having a plurality of cylinder heads;
a plurality of manifold sections configured to connect with each other and thereby form an exhaust manifold, each of the plurality of manifold sections having an integral exhaust runner extending from an annular wall;
a plurality of a coolant adapters, each configured to connect a corresponding integral exhaust runner to a corresponding one of the plurality of cylinder heads, and having a jacket formed therein;
a plurality of couplings, each configured to connect a coolant outlet of the corresponding one of the plurality of cylinder heads with the jacket via an outboard side of a corresponding one of the plurality of coolant adapters;
a coolant manifold configured to receive coolant from the plurality of coolant adapters via an inboard side of each of the plurality of coolant adapters;
a heat shield formed around the exhaust manifold; and
a turbocharger driven by exhaust in the exhaust manifold to pressurize air directed into the engine.

20. The power system of claim 19, wherein:
the heat shield is supported by the plurality of a coolant adapters; and
the heat shield encompasses the exhaust manifold on at least three sides.
